(19) United States
(12) Patent Application Publication
(10) Pub. No.: US 2003/0195922 A1
(43) Pub. Date: Oct. 16, 2003

(54) SNMP trap and inform shaping mechanism

(75) Inventors: Ken Andrews, Reston, VA (US); Clive Butler, Reston, VA (US)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/118,894

(22) Filed: Apr. 10, 2002

(51) Int. Cl. G06F 9/46; G06F 15/16; G06F 15/173

(52) U.S. Cl. 709/202; 709/223

(57) ABSTRACT

At system initialization, the core routers and the edge routers will begin to exchange routing information that is required for the network to become operational. The notification shaping method of the present invention can be used to prevent the core router from flooding the edge routers with notifications while the edge routers are trying to process routing updates. In the present invention, notifications are sent in a steady flow, and not in bursts. The notification shaping method uses a timer to process the notifications stored in the notification queue. In addition, the notification shaping method comprises three basic steps. Step 1 comprises putting an entry on the notification queue. Step 2 comprises timer expiration. Step 3 comprises responding to an inform.

### FIELD OF THE INVENTION

The invention is related to the management of traffic flow in a router. More particularly, this invention relates to managing the output notification queue.

### BACKGROUND OF THE INVENTION

SNMP defines a protocol used to define management information. Managers and agents exchange messages. SNMP determines the format and meaning of the messages. It also determines the representation of names and values within those messages.

Agents may be equipped with SNMP so that a manager can manage them. The agent responds to requests from the manager. Such requests include requests for information and requests to perform certain actions. In addition, an agent may asynchronously provide unsolicited information to the management server. SNMP defines a get-request, a get-next-request, a get-response and a set-response command to provide fetch and store operations between the agent and the manager.

### SUMMARY OF THE INVENTION

In a preferred embodiment, the invention comprises a router comprising a rack, at least one line card operably connected to the rack, at least one switching fabric card operably connected to the line card, a management server comprising management software stored in a first memory, a database operably connected to the management server, a route server comprising routing software stored in a second memory operably connected to the line card and a database operably connected to the management server.

In another preferred embodiment, the management server comprises a master agent-subagent architecture which comprises a manager and a master agent-subagent operably connected to the manager. The master agent-subagent comprises a queue notification generator, a notification queue operably connected to the queue notification generator, a timer operably connected to the notification queue and a retransmission queue operably connected to the timer.

In still another preferred embodiment, the invention further comprises a method of controlling the flow of notifications, comprising the steps of putting an entry on a notification queue, expiring a timer and responding to an inform.

In still another preferred embodiment, the step of putting an entry on a notification queue further comprises acknowledging the entry if it is an inform, transmitting the notification if a transmission rate is below a threshold, discarding the notification if the transmission rate is above the threshold and the notification queue is full, and adding the notification to the notification queue if the transmission rate is above the threshold and the notification queue is not full.

In still another preferred embodiment, the step of expiring a timer further comprises finding a first notification pointed to by a notification root, removing and sending the first notification, checking if a notification window is open, removing and sending another notification if the notification window is open, checking if there are any of the notifications on the queue if the notification window is not open, logging a warning if the notification window is not open and there are none of the notifications on the queue, and setting another timer if the notification window is not open and there are notifications on the queue.

In still another preferred embodiment, the the step of responding to an inform further comprises receiving the inform, and locating and destroying any queued retransmissions.

### BRIEF DESCRIPTION OF THE DRAWINGS

FIG. 1 shows a chassis or a rack in a physical network server, the 7770 RCP Router, containing a number of boards.

FIG. 2 illustrates three external management interfaces.

FIG. 3 illustrates users of the management interface.

FIG. 4 illustrates a SNMP Master Agent-Subagent architecture.

FIG. 5 illustrates notifications sent through an upstream router.

FIG. 6 is illustrates the network topology.

FIG. 7 is a flowchart illustrating the steps taken in putting an entry on queue.

FIG. 8 is a flowchart illustrating the steps taken in timer expiration.

FIG. 9 is a flowchart illustrating the steps taken in responding to an inform.

### DETAILED DESCRIPTION OF THE INVENTION:

During system initialization, there is generally a large burst of notifications that can often flood both the network and network management systems. In the present invention, notifications are sent in a steady flow, and not in bursts.

7770 RCP Router

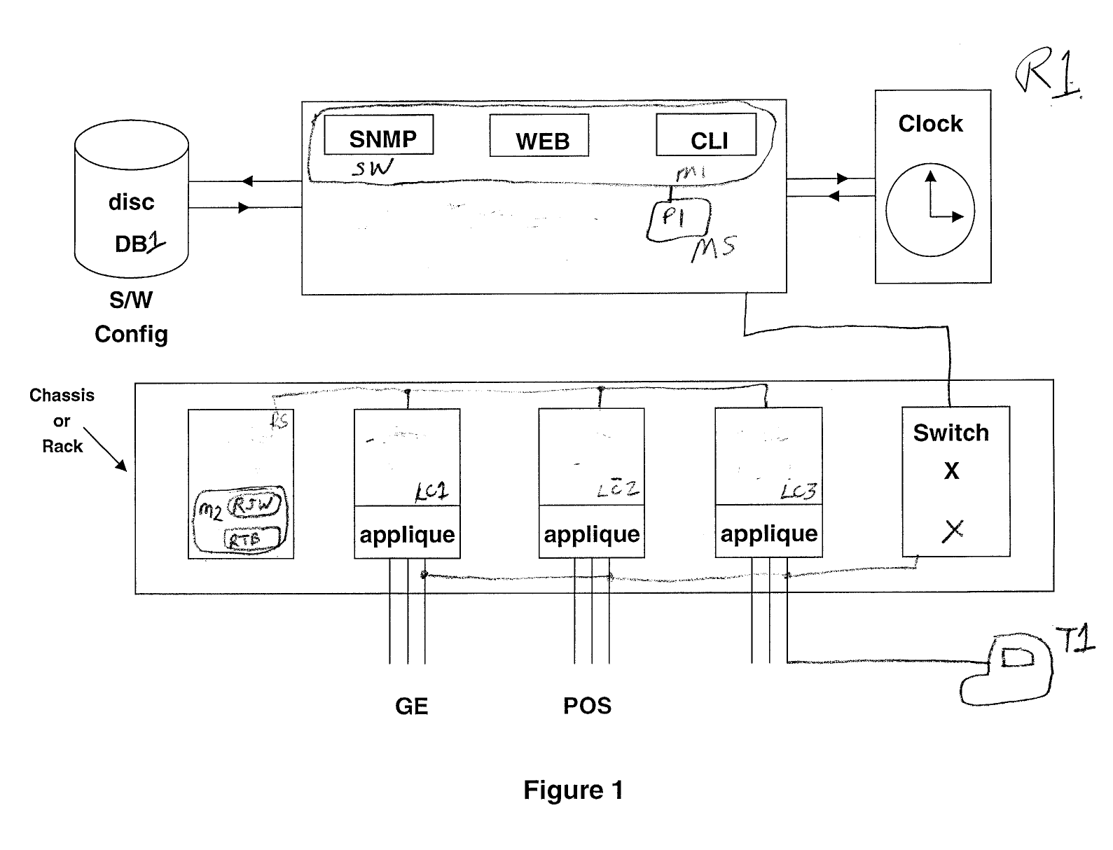

FIG. 1 shows a chassis or a rack in a physical network server, the 7770 RCP Router, containing a number of boards. Connection to the physical network is through the line cards (LC1, LC2, LC3). These cards can be either Ethernet cards or SONET cards. In a preferred embodiment, they are gigabit Ethernet (GE) cards or packet over sonet (POS) cards, each comprising an applique.

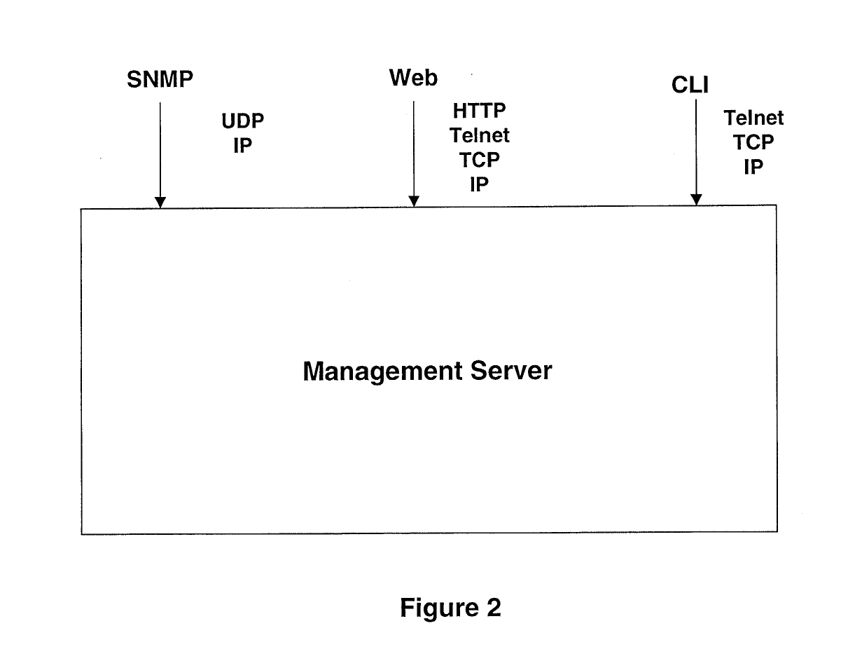

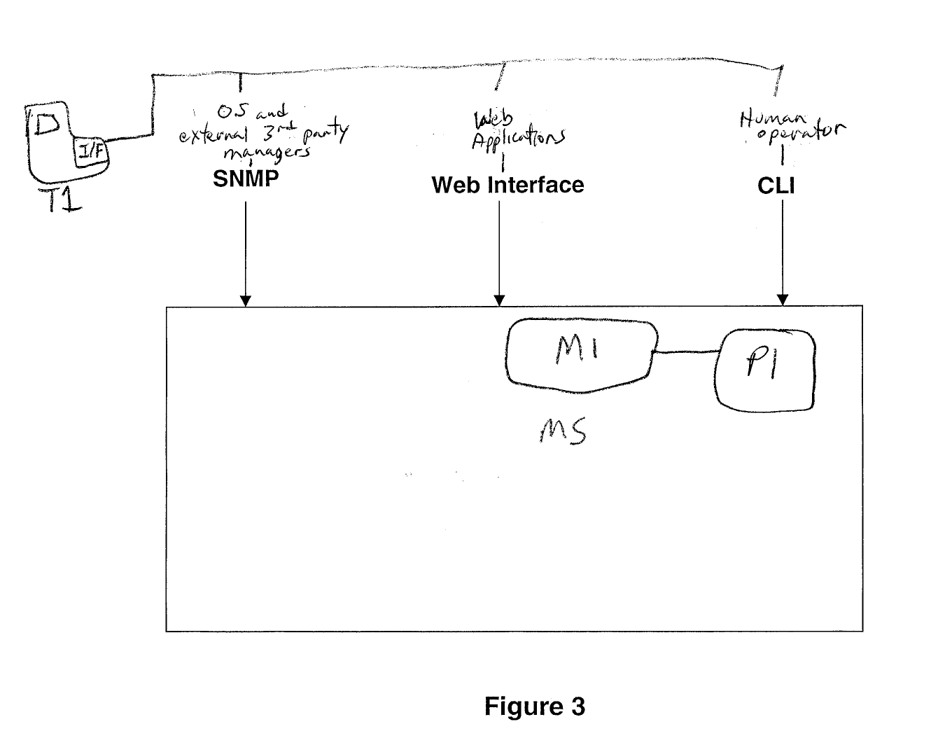

The management server (MS) is a separate board that holds the management software (SW) stored in memory (M1). Management software (SW) (or the manager) can request operational data or receive event notifications from an agent by using a management protocol. Three different management protocols are used by the software: 1) Simple Network Browser Protocol (SNMP), 2) Web browser interface (WEB), or 3) Command Line Interface (CLI). They can also be referred to as 3 different management interfaces. FIG. 2 illustrates three external management interfaces. Users of the three management interfaces (FIG. 3) are as follows.

OS and external 3^{rd} party managers use SNMP. Therefore, third party applications use the SNMP interface. Fault management and network monitoring also use the SNMP interface.

Web applications such as HTML pages and Java applets use the Web interface. In addition, configuration management and diagnostic applications use the Web interface.

Human operators use CLI. (See FIG. 3). The system configuration is stored in a database (dB1). See FIG. 1. The configuration information stored in the database (dB1) is used to load all the line cards (LC1, LC2, LC3). In addition, the management server (MS) comprises an operator interface (I/F). The management server or station comprises a processor P1. Connected to the management server (MS) is a terminal T1. The terminal T1 comprises an interface (I/F) through which the user can interact with the manager software (SNMP, WEB, or CLI) running on the processor (P1). Processor P1 is operably connected to memory M1. In a preferred embodiment, the management software (SW) is downloaded to memory located on processor P1 when in use. In another preferred embodiment, memory Ml can be located on processor P1 in the form of firmware.

There are also switching fabric (switch) cards (X). These switching fabric cards (X) allow ports on the line cards to speak with each other. This enables packets input through one line card (LC1, LC2, LC3) to be switched through the network and out another card (LC1, LC2, LC3).

The route server (RS) is a separate board that holds routing software (RSW). Routing software (RSW) comprise protocols that hold IP addresses and create routing tables (RTB) containing routes to each of these IP addresses. The routing tables are stored in memory (M2). The memory (M2) can be RAM, ROM, compact disc or any other type of media storage. The routing server (RS) can share these routing tables (RTB) with line cards and distribute the tables (RTB) to the line cards. The route server (RS) uses these routing tables (RTB) to send and receive network protocol data units called data packets. The route server (RS) will relay packets from one peripheral or device or to another device in the network. A router is also referred to as a Gateway in the TCP/IP protocol.

The normal method of managing a system is for an operator to log into the network through a terminal (T1). The terminal (T1) can be a personal computer (PC) connected to the network. The PC sends a packet to the system through a line card (LC1, LC2, LC3). The line card (LC1, LC2, LC3) is routed or switched to the management server (MS). See FIG. 1.

In the current system, the operator enters all commands using the SNMP interface, even if the operator desires to use the WEB or the CLI protocol. Commands are mapped from the SNMP protocol to the WEB or CLI protocol. This avoids having to implement everything three times. Therefore, to the internal architectures it appears as if all commands came from an SNMP user. The internal mapping is done using a translation facility called MibWay, purchased from the RapidLogic division of WindRiver Inc.

AgentX

An agent monitors and accumulates operational data and detects exceptional events for each network element. There can be one agent for the whole box, or we can have one master agent (MA) and a subagent (SA) for each major software application that is running. The master agent (MA) communicates with the subagent (SA) through a protocol called AgentX. The present invention comprises an extension to the AgentX protocol and the SNMP master agent processing for a multi-interface management architecture that is modeled using SNMP internally. The extension allows information to be reported back to CLI and WEB operators. In a preferred embodiment, this extension is used in a model 7770 RCP router (7770 RCP). For the Master Agent, the code used by the SNMP Master Agent is to map messages between protocols operates as a filter.

Standard SNMP Subagent Architecture

The 7770 RCP router (R1) uses an SNMP Master Agent-Subagent architecture internally for processing management operations. The Master Agent (MA) receives SNMP messages from external SNMP managers, and distributes them internally as AgentX messages to multiple subagents (SA) within the router (R1). The subagents (SA) route the messages to corresponding applications. The subagents (SA) return responses from the applications to the master agent (MA). Each management subagent (SA) may service multiple applications. Typically, a subagent (SA) services one type of application (e.g., IP forwarding) on all boards. In the 7770 RCP router (RI) the subagent (SA) can service up to 30 TLKs, although the present inventions can apply to systems where each subagent (SA) can service even greater numbers.

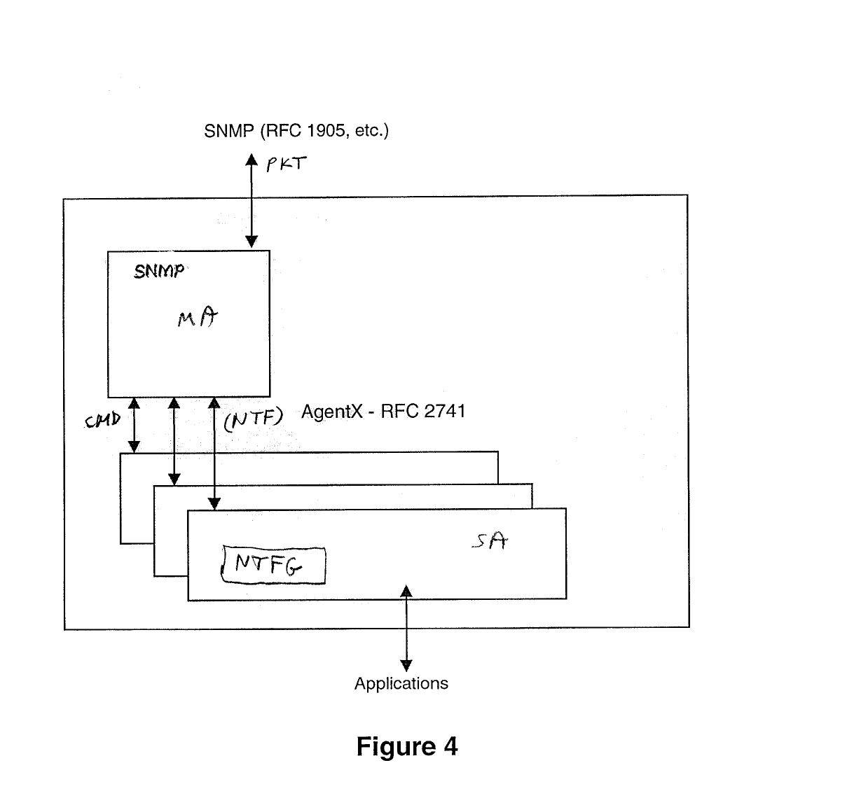

FIG. 4 discloses a SNMP Master Agent-Subagent architecture (MA-SA). In FIG. 4, configuration commands (CMD) are sent as AgentX messages to the subagents (SA) that support internal applications. Data or error notifications (NTF) from internal applications are sent back as AgentX response messages towards the master agent (MA). See RFC 2741, Daniele, January 2000, Agent Extensibility (AgentX) Protocol Version 1, hereby incorporated by reference. Then, they are translated into SNMP response packets (PKT) containing either data or an SNMP-defined error status value. See RFC 1905, Case, January 1996, Protocol Operations for Version 2 of the Simple Network Management Protocol (SNMPv2), hereby incorporated by reference.

7770 RCP Subagent Architecture

The 7770 RCP Master Agent-Subagent architecture (MA-SA) also includes a link to a Web Interface (WEB) and a Command Line Interface (CLI). The Web commands and the CLI commands are translated into AgentX messages. They share the same internal processing as the equivalent SNMP commands.

SNMP Trap and Inform Shaping Mechanism

In addition to the fetch and store commands discussed above, SNMP also defines a trap command. The master agent (MA) uses the trap command to asynchronously send information to a manager (SW) triggered by an event. For example, the master agent (MA) informs the SNMP manager (SW) of any unusual events in the network. One such unusual event consists of a line which is down. The agent or router will send a notification when a line goes down. The notification can be a trap or an inform. (Traps require acknowledgement, while informs do not). One example of a trap for a downed line can consist of a screen at the SNMP manager (SW) flashing red. Another example of a trap can consist of a page sent to an operator. Other examples of unusual events include the failure of a link or an overload condition which occurs because a packet load crossed a threshold.

Also, an agent uses a trap to notify the manager (SW) of significant events. For example, when a router (R1) initially boots up, all the peripherals such as the boards and the cards come online. A master agent (MA) uses traps to inform the SNMP manager (SW) which peripherals are online.

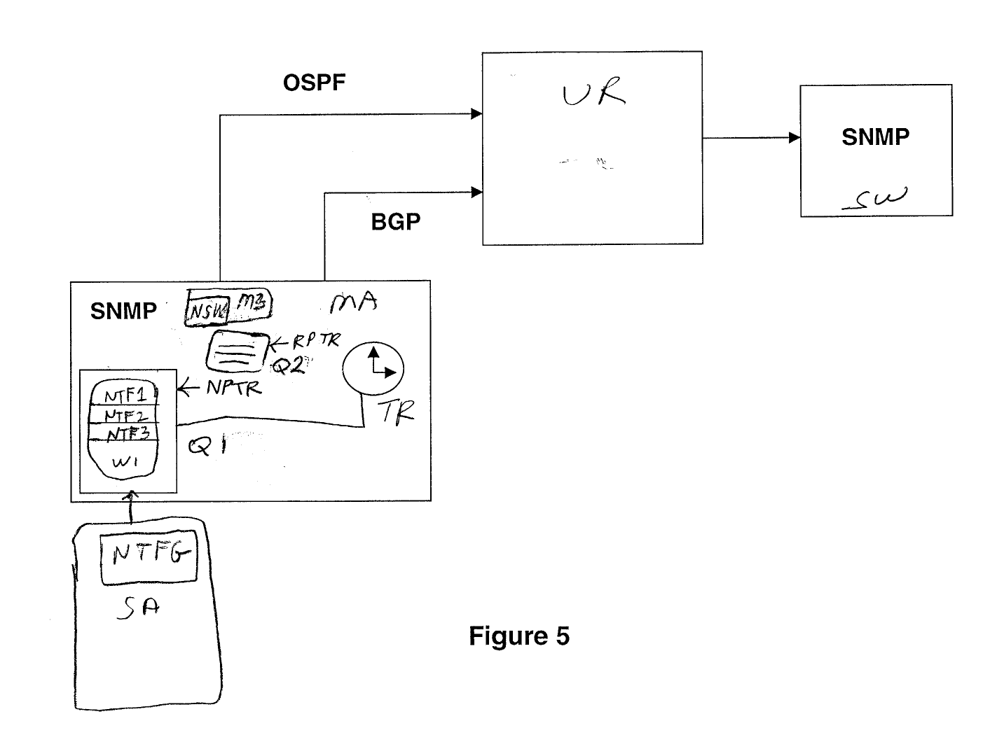

However, the notifications (NTF) are sent through an upstream router (UR) which is generally very busy (see FIG. 5). Consequently, the notifications (NTF) will be dropped into a notification queue (Q1). If the notification queue (Q1) is full, then the notification (NTF) will be discarded. A first in, first out (FIFO) protocol is used to process notifications (NTF) in the queue (Q1). The system does not directly respond to a notification or query (NTF). In the present invention, the notification (NTF) will first be stored in the queue (Q1).

A traffic management problem occurs when the system is rebooted when a large number of messages are stored in the queue (Q1) ready to be processed. A large number of messages are sent to the SNMP manager (SW) in a very short time frame.

In the present invention, notifications (NTF) are transmitted in a steady flow and not in bursts. The notification shaping method of the present invention uses a timer (TR) to process the notifications stored in the notification queue (Q1). See FIG. 5. The timer can be a processor, a microprocessor, a central processing unit or any of a number of processing means including analog processing means. The transmission rate for sending the notification messages is set at a maximum of n messages in m seconds. The notification rate has a range of 1 to 255 notifications per second with a default of 10. If the notification rate is set to zero, notification shaping is disabled. The timer (TR) controls the notification transmission rate. If a notification (NTF) is received at the queue (Q1) and the notification transmission rate is below the maximum, the notification (NTF) is forwarded. If not, the notification (NTF) remains in the queue until it is time for it to be forwarded using the FIFO protocol. As a result, notifications (NTF) will be transmitted in a steady flow and not in bursts.

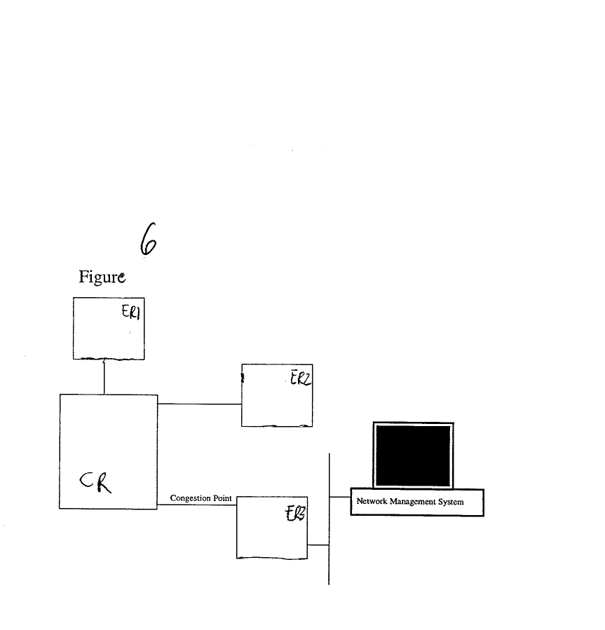

At system initialization, the core routers (CR) and the edge routers (ER1, ER2, ER3) will begin to exchange routing information that is required for the network to become operational. At the same time, the core router (CR) starts to send notifications (NTF), the reporting system, card and interface status information to the Network Management System (see FIG. 6 which shows the Network Topology). The notification shaping method of the present invention can be used to prevent the core router (CR) from flooding the edge routers (ER1, ER2, ER3) with notifications (NTF) while the edge routers (ER1, ER2, ER3) are trying to process routing updates. Thereby, congestion is reduced.

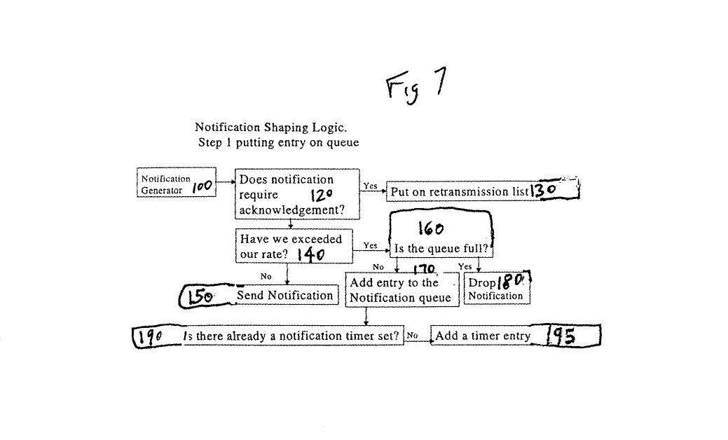

FIGS. 7, 8 and 9 illustrate the three basic steps involved in the notification shaping method of the present invention. These steps can be stored in software (NSW) stored in memory (M3) on the Master Agent (MA).

FIG. 7 is a flowchart which illustrates step 1, putting an entry on the notification queue (Q1).

Step 100 comprises a queue notification generator or notification generator (NTFG) generating an entry. It is operably connected to the notification queue (Q1). AgentX subagents (SA) typically initiate notifications (NTF). The master agent (MA) will then determine if they are to be sent to the SNMP manager (SW) as traps which do not require acknowledgement (ACK) or as informs (IN) which do require a response.

Does notification (NTF) require acknowledgement (ACK) (Step 120)? As stated above if a notification (NTF) is an inform (IN) it will require an acknowledgement (ACK). If that acknowledgement (ACK) is not received within a pre-defined period of time, then the inform (IN) will be re-transmitted. This re-transmission can occur a pre-defined number of times before the inform (IN) is considered “dead”.

Put inform (IN) on the retransmission list (RLST) (Step 130). A retransmission list (RLST) is a list of all informs (IN) that is kept so that they can be re-transmitted if no response is sent. In a preferred embodiment, it is stored in memory located in the master agent (MA).

Has the notification transmission rate been exceeded (Step 140)? This is determined by counting the number of notifications (NTF) that was sent in the last second.

If the answer to step 140 is no, then send the notification (NTF) (Step 150). At this point no additional shaping or queuing is needed. The notification (NTF) is sent to its destination.

If the answer to step 140 is yes, then is the queue (Q1) full (Step 160)? The queue depth will be checked at this point. (The notification queue depth has a range of 0 to 255 with a default of 10. If this feature is set to 0, it is turned off.) If it is equal or greater than the defined maximum depth, then the notification will be discarded. Note that if there is an entry on the re-transmission list (RLST), it will be left on the list since after the timeout, the queue (Q1) may no longer be full and the inform can be sent or queued for sending.

If the queue (Q1) is not full, then add the notification entry to the notification queue (Q1) (Step 170). The notification queue (Q1) is a linked list of data structures. When an entry is added it will be added to the end of the list. At this point the queue depth is recalculated.

If the queue (Q1) is full, then drop the notification (NTF) (Step 180).

If step 170 is performed (the queue (Q1) is not full and the entry was added to the notification queue) then ask the question is there already a timer (TR) set (Step 190)? Setting the timer (TR) enables the system to come back and check the queue (Q1) and send its window of notifications (NTF). The timer is operably connected to the notification queue (Q1).

If the answer to step 190 is no (a timer (TR) is not set), then add the timer entry (Step 195): This will check to see if there is a timer (TR) set and if there is not it will create and set one.

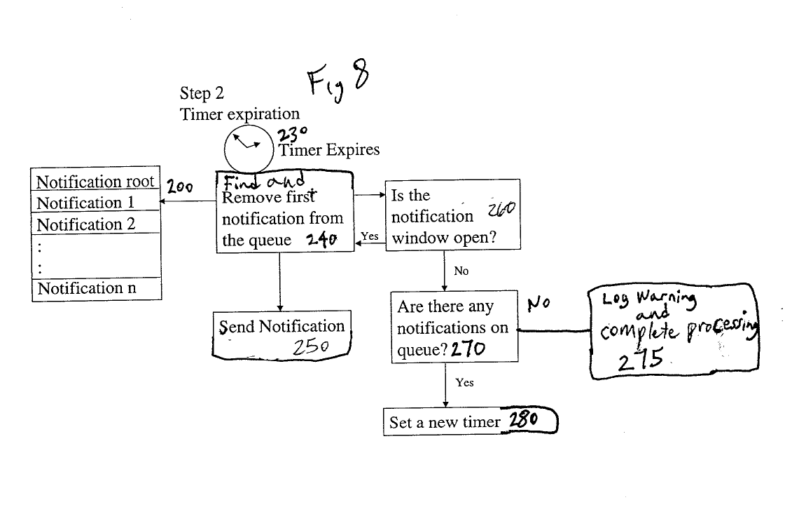

FIG. 8 illustrates step 2, Timer Expiration. The notification root is a structure that points to the oldest entry in the notification queue (Q1). The notification queue (Q1) is a linked list of data structures. Step 200 consists of pointing to the first notification (NTF1, NTF2, NTF3) in the notification queue (Q1).

The operation of the timer (TR) is a generic timer operation. Step 230 occurs when the timer (TR) expires.

When the timer (TR) expires, a function is called that finds the notification (NTF) pointed to by the notification root (NPTR). The first notification (NTF1) is removed from the queue (Q1) (Step 240) and sent (Step 250).

Next, the notification window (W1) is checked to see if it is open “is the notification window (W1) open?” (Step 260). If the notification window (W1) is open, then remove the next notification from the queue (Q1) and send the notification (Step 250).

If the notification window is not open then the next query is “are there any notifications (NTF) on queue (Q1) (270)?” If there are no notifications on the queue (Q1), then a warning is logged and processing is complete (275).

If there are still notifications remaining, then a new timer (TR) must be set. Thus, if the answer to step 270 is yes, then step 280 is to set a new timer (TR). Thus, another timer (TR) is set to determine when the system should check the queue (Q1).

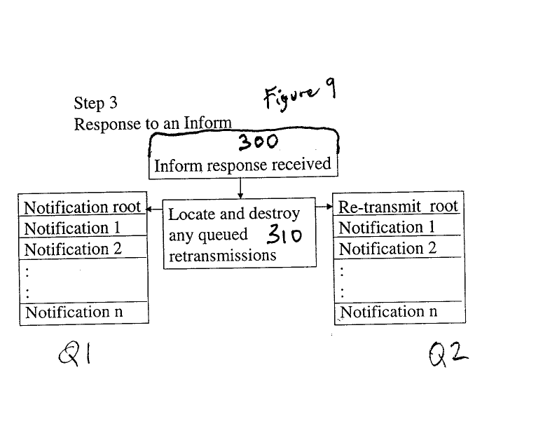

FIG. 9 illustrates step 3, response to an inform. In FIG. 9, the notification root (NPTR) is a structure that points to the oldest entry in the notification queue (Q1). The notification queue (Q1) is a linked list of data structures. The retransmit root (RPTR) is a structure which points to entries that indicate that an inform is being processed and that no response has yet been received for.

In step 300, the inform response is received. As stated above, if a notification (NTF) is an inform it will require an acknowledgement (ACK). If that acknowledgement (ACK) is not received within a pre-defined period of time then the inform will be re-transmitted. In a preferred embodiment, a response to an inform is a get response message.

Next, step 310 involves locating and destroying any queued retransmissions. This process steps though the retransmission queue or retransmission list (Q2) and removes the entry that has been responded to. Since a timeout may have occurred that would cause a retransmission to be placed on the notification queue (Q1), that queue (Q1) will also be scanned to see if there is an entry for that notification (NTF) on the notification queue (Q1). If one is found it is removed.

While the invention has been disclosed in this patent application by reference to the details of preferred embodiments of the invention, it is to be understood that the disclosure is intended in an illustrative, rather than a limiting sense, as it is contemplated that modifications will readily occur to those skilled in the art, within the spirit of the invention and the scope of the appended claims and their equivalents.

What is claimed is:

1. A router, comprising:
a rack;
at least one line card operably connected to said rack;
at least one switching fabric card operably connected to said at least one line card;
a management server comprising management software stored in a first memory operably connected to said at least one switching fabric card;
a route server comprising routing software stored in a second memory operably connected to said line cards; and
a database operably connected to said management server.

2. The router according to claim 1, wherein said management server comprises a master agent-subagent architecture.

3. The router according to claim 2, wherein said master agent-subagent architecture comprises:
a manager; and
a master agent-subagent operably connected to said manager, comprising:
a notification generator;
a notification queue operably connected to said notification generator;
a timer operably connected to said notification queue; and
a retransmission queue operably connected to said timer.

4. The router according to claim 3, further comprising a notification root operably connected to said notification queue, whereby notifications stored in said notification queue are pointed to.

5. The router according to claim 3, further comprising a retransmission root operably connected to said retransmission queue, whereby notifications stored in said retransmission queue are pointed to.

6. The router according to claim 3, wherein said routing software comprise protocols that hold IP addresses and create routing tables containing routes to each of said IP addresses.

7. The router according to claim 3, wherein said line cards are SONET cards.

8. The router according to claim 3, wherein said line cards are Ethernet cards.

9. The router according to claim 3, wherein a system configuration is stored in said database.

10. The router according to claim 3, wherein said manager comprises a management protocol.

11. The router according to claim 3, wherein said manager is a simple network browser protocol manager.

12. The router according to claim 10, wherein said management protocol is a simple network browser protocol.

13. The router according to claim 12, further comprising:
a notification root operably connected to said notification queue, whereby notifications stored in said notification queue are pointed to;
a retransmission root operably connected to said retransmission queue, whereby notifications stored in said retransmission queue are pointed to; and
wherein said routing software comprise protocols that hold IP addresses and create routing tables containing routes to each of said IP addresses, wherein said line cards are SONET cards, wherein said line cards are Ethernet cards, wherein a system configuration is stored in said database, and wherein said manager is a simple network browser protocol manager.

14. An apparatus to control the flow of notifications, comprising:
a manager; and
a master agent-subagent operably connected to said manager, comprising:
a notification generator;
a notification queue operably connected to said notification generator;
a timer operably connected to said notification queue; and
a retransmission queue operably connected to said timer.

15. The apparatus according to claim 14, further comprising a notification root operably connected to said notification queue, whereby notifications stored in said notification queue are pointed to.

16. The apparatus according to claim 14, further comprising a retransmission root operably connected to said retransmission queue, whereby notifications stored in said retransmission queue are pointed to.

17. The apparatus according to claim 14, wherein said manager comprises a management protocol.

18. The apparatus according to claim 14, wherein said manager is a simple network browser protocol manager.

19. The apparatus according to claim 14, wherein said manager comprises a simple network browser management protocol.

20. The apparatus according to claim 15, further comprising:
a retransmission root operably connected to said retransmission queue, whereby notifications stored in said retransmission queue are pointed to; and
wherein said manager comprises a simple network browser protocol and is a simple network browser protocol manager.

21. An apparatus to control the flow of notifications, comprising:
an agent, comprising:
a notification generator;
a notification queue operably connected to said notification generator;
a timer operably connected to said notification queue; and
a retransmission queue operably connected to said timer.

22. The apparatus according to claim 21, further comprising a notification root operably connected to said notification queue, whereby notifications stored in said notification queue are pointed to.

23. The apparatus according to claim 21, further comprising a retransmission root operably connected to said retransmission queue, whereby notifications stored in said retransmission queue are pointed to.

24. The apparatus according to claim 21, wherein said agent is operably connected to a manager comprising a management protocol.

25. The apparatus according to claim 21, wherein said agent is a simple network browser protocol agent.

26. The apparatus according to claim 24, wherein said manager comprises a simple network browser management protocol.

27. The apparatus according to claim 22, further comprising:
a retransmission root operably connected to said retransmission queue, whereby notifications stored in said retransmission queue are pointed to; and
a manager operably connected to said agent comprising a simple network browser protocol.

28. A method of controlling the flow of notifications, comprising the steps of:
putting an entry on a notification queue;
expiring a timer; and
responding to an inform.

29. The method controlling the flow of notifications according to claim 28, wherein said step of putting an entry on a notification queue further comprises:
acknowledging said entry if it is an inform;
transmitting the notification if a transmission rate is below a threshold;
discarding the notification if said transmission rate is above said threshold and said notification queue is full; and
adding the notification to said notification queue if said transmission rate above said threshold and said notification queue is not full.

30. The method of controlling the flow of notifications according to claim 28, wherein said step of expiring a timer further comprises:
finding a first notification pointed to by a notification root;
removing and sending said first notification;
checking if a notification window is open;
removing and sending another notification if said notification window is open;
checking if there are any said notifications on said queue if said notification window is not open;
logging a warning if said notification window is not open and there are no said notifications on said queue; and
setting another timer if said notification window is not open and there are said notifications on said queue.

31. The method of controlling the flow of notifications according to claim 28, wherein said step of responding to an inform further comprises:
receiving the inform; and
locating and destroying any queued retransmissions.

32. The method of controlling the flow of notifications according to claim 29, wherein said step of expiring a timer further comprises:
finding a first notification pointed to by a notification root;
removing and sending said first notification;
checking if a notification window is open;
removing and sending another notification if said notification window is open;
checking if there are any said notifications on said queue if said notification window is not open;
logging a warning if said notification window is not open and there are no said notifications on said queue; and
setting another timer if said notification window is not open and there are said notifications on said queue; and
wherein said step of responding to an inform further comprises:
receiving the inform; and
locating and destroying any queued retransmissions.

33. The method according to claim 32, further comprising the step of putting said inform on a retransmission list.

34. The method according to claim 32, further comprising the step of adding a timer entry if transmission rate above a threshold and notification queue is not full and a timer is not set.

35. The method according to claim 32, further comprising the step of determining if said transmission rate is above a threshold by counting the number of notifications sent in the last second.

36. The method according to claim 32, wherein said step of locating and destroying any queued retransmissions further comprises the step of removing an entry from a retransmission queue that has been responded to.
